(19) United States
(12) Patent Application Publication
(10) Pub. No.: US 2004/0189258 A1
(43) Pub. Date: Sep. 30, 2004

(54) Service life monitoring for an injection device

(76) Inventors: Hens-Ulrich Lehmann, Trachselwald (CH); Beat Steffen, Saanen (CH)

Correspondence Address: David E. Bruhn, DORSEY & WHITNEY LLP, Intellectual Property Department, 50 South Sixth Street, Suite 1500, Minneapolis, MN, 55402-1498, US

(21) Appl. No.: 10/817,296

(22) Filed: Apr. 2, 2004

Related U.S. Application Data
(63) Continuation of application No. PCT/CH02/00530, filed on Sep. 23, 2002.

(30) Foreign Application Priority Data
Oct. 4, 2001 (DE) 10 48 832.7

(51) Int. Cl. H02J 7/00; F02M 1/00

(52) U.S. Cl. 320/132; 604/111

(57) ABSTRACT

A device for monitoring the service life of injection devices, including needleless injection devices. A method for monitoring the service life of needleless injection devices is also encompassed.

### CROSS-REFERENCE TO RELATED APPLICATION(S)

This application is a continuation of International Application No. PCT/CH02/00530, filed on Sep. 23, 2002, which claims priority to German Application No. 101 48 832.7, filed on Oct. 4, 2001, the contents of both of which are incorporated herein by reference in their entirety.

### BACKGROUND

The present invention relates to medical devices and methods for their use and maintenance, including injection devices and, in particular, so-called needle-free or needleless injection devices. There are many known embodiments of needle-free or needleless injection devices. Two examples are disclosed in U.S. Pat. No. 5,911,703 (spring driven) and U.S. Pat. No. 6,676,630 (pressurized gas delivery mechanism), the disclosures of which are incorporated herein by reference.

In needle-free injection devices, a substance to be injected is provided in the injection device before the injection procedure. The substance, which is customarily dispense in the form of a jet of liquid, must be accelerated to a relatively high velocity within a relatively short period of time using suitable means in order to have enough kinetic energy for the skin of a patient to be penetrated solely by the substance to be dispensed. For this purpose, it is necessary to be able to store a relatively large amount of energy, to be rapidly dispensed, in the injection device. To this end, in some injection device, spring mechanisms are used as energy stores.

Relatively large mechanical stresses arise in needle-free injection devices, due to the necessary high initial acceleration of the substance to be dispensed. These stresses have an effect on the reliability of a needle-free injection device when the injection device is used repeatedly. In particular, when used frequently, the quality of the injection device may be begin to deteriorate. For example, after a certain number of tensing procedures of a strong spring provided in the injection device and a certain number of dispensing procedures, the dosing precision may begin to decrease due to the large mechanical demands on the needle-free injection device. In the worst case scenario, the injection device no longer functions properly. This may be the case, for example, if the spring or other parts of the injection device, due to material fatigue, cannot sufficiently accelerate the substance to be injected, such that an injection procedure can no longer be performed effectively, since the patient's skin can no longer be penetrated.

An important prerequisite for an injection device is that it be approved as necessary by appropriate regulatory authorities. Obviously, the injection device must function properly and accurately, including over an extended period of use.

Another potential problem with known devices is that, after a particular injection amount has been dispensed, it is necessary to tense or load the energy store, e.g., a spring, again. For this purpose, however, a relatively large force, for example 400 N in some devices, is necessary, which children, older persons, or infirm persons often cannot at all or cannot easily apply.

### SUMMARY

It is an object of the present invention to provide a needle-free injection device which ensures that only proper injection procedures can be performed.

In accordance with the present invention, a service life monitoring system and method is provided for needle-free injection devices.

In some preferred embodiments, the service life monitoring system counts the number of charging procedures and/or discharging procedures of an energy store, such as for example a spring mechanism or a gas pressure mechanism.

In some preferred embodiments, the service life monitoring system and the device(s) with which it is used or associated can display the number of charging and/or discharging procedures performed in order to be able to monitor, check or assess the condition of the injection device. In some preferred embodiments, the service life monitoring system can alternatively or also, measure the period of time from a particular designated point in time, e.g., when it was manufactured or operated for the first time, and emit a signal when any predetermined period of time, for example a few months or years, has elapsed. In some embodiments, the service life monitoring system and method of the present invention can be based on a combination of the above principles, wherein, for example, a period of time can be counted as if an additional injection or number of injections had been performed. This would account for aging fatigue.

In general, the service life monitoring system can be configured such that an end of the service life (end-of-life) is determined by any appropriate method or standard. It may come after a particular number of charging or dispensing procedures, after a predetermined period of time has elapsed, or after a selected combination of charging procedures and elapsed time units.

In some embodiments, upon reaching the end of its useful life, an injection device may be adapted to disable itself, i.e., no further injection can be performed using the disabled injection device. For this purpose, a suitable moving part or function necessary for performing an injection can, for example, be irreversibly locked or otherwise disabled.

In some embodiments, the number of charging or injection procedures can be stored in an electronic memory, advantageously a static or non- volatile memory such as an EEPROM, which may or has to be read or written on only when a charging or injection procedure is performed, in order to store the number of charging or injection procedures actually performed in the EEPROM.

In some preferred embodiments, an automatic disabling device is provided which prevents the energy store from being re-charged again. Such a disabling device may be adapted prevent an injection procedure from being performed when a particular number of charging procedures or injections has been performed, and/or when a particular period of time has elapsed.

In some preferred embodiments, an optical and/or acoustic output device is provided for outputting the number of charging and/or injection procedures performed, and/or for outputting a warning signal before or when a predetermined maximum number of charging and/or injection procedures is reached and/or a predetermined period of time has elapsed.

Advantageously, an output device is provided which can be coupled to the service life monitoring system, in order to display the number of charging or injection procedures performed, e.g., a mechanical or electronic counter. It is furthermore advantageous to provide a warning device which signals the imminent or actual end of the service life of the injection device, e.g., a red LED, a flashing light, an acoustic warning signal, a tactile signal, or other suitable display or signal.

Alternatively, a service life monitoring system in accordance with the present invention could be provided in a separate device to which an injection device is regularly or periodically coupled, in order to charge the energy store (e.g., a spring, a pressurized gas device or other suitable structure) for a new injection procedure. The service life can then advantageously be monitored by automatically restricting the number of charging procedures which may be performed.

The concept or principle of providing a rechargeable working or operating item and a separate recharging unit to which the item can be coupled to be recharged is, of course, well known and used in many and divers areas, from toys to toothbrushes. This concept or principle, which is part of some embodiments of the present invention, is exemplified by U.S. Pat. No. 6,446,294 (rechargeable toothbrush with charge level display) and U.S. Pat. No. 5,554,154 (rechargeable medical drill which can be recharged electrically or mechanically). The disclosures and teaching of these patents regarding recharging or rechargeability are incorporated herein by reference.

In some embodiments of the present invention, a charging device and/or an injection device in accordance with the present invention comprise an allocation recognition system. The allocation recognition system enables a particular needle-free injection device to be clearly identified, in order to, for example, be able to charge a number of injection devices on the same charging device for new injection procedures, simultaneously monitor the number of charging procedures performed, and possibly to disable further charging if a maximum number of charging procedures approved for a particular needle-free injection device has been reached.

In accordance with another aspect of the invention, which can be used together with or independently of the service life monitoring system described above, a charging device for an injection device is provided, using which an energy store in the injection device necessary to perform a needle-free injection can be charged, for example, a spring tensed or a pressurized gas system loaded with pressurized gas. Consequently, the invention also relates to an injection device comprising a charging device without a service life monitoring system.

For this purpose, a gas pressure providing system can advantageously be provided in the charging device, e.g., an exchangeable gas cartridge which stores pressurized gas in a metal container. Such gas cartridges are commercially available. If the injection device is coupled to the charging device, then the pressurized gas system provided in the injection device can be charged by pressurized gas from the charging device. It is particularly advantageous to use pressurized gas systems when using materials which can only be mechanically stressed to a restricted degree, such as plastic, since large stresses do not then arise due to the mechanical parts moved during the charging procedure.

In some preferred embodiments, the charging device can comprise an electric energy store comprising an electric drive using which the energy store of the injection device can be charged. For example, a spring can be tensed by an electric motor and a spindle, or a pressurized gas system can be suitably re-pressurized by means of an electric motor. A connection to an external mains supply can, however, could also be provided on the charging device.

In accordance with another aspect of the present invention, the invention provides embodiments of a method for monitoring the service life of a needle-free injection device. Advantageously, the number of charging and/or injection procedures is counted, in order to monitor the service life. In some embodiments, this number can be outputted optically or acoustically, e.g., as a speech output. In some preferred embodiments, further charging and/or injection procedures are disabled if a predetermined maximum number of such procedures is reached and/or a predetermined period of time has elapsed or a combination of these events has occurred.

### BRIEF DESCRIPTION OF THE DRAWINGS

FIG. 1 depicts, in representative form, a charging device adapted to monitor the service life of an injection device, particularly a needle-free injection device.

### DETAILED DESCRIPTION

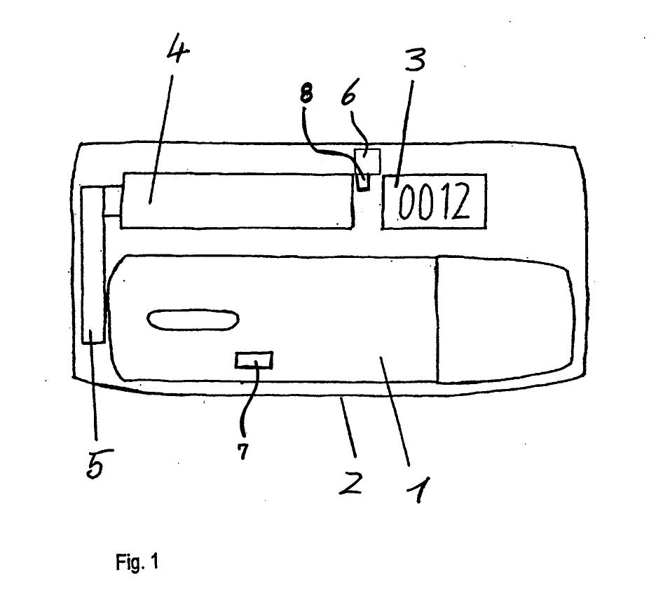

Referring to FIG. 1, a needle-free injection device 1 is connected to a charging device 2. In some embodiments, the charging device 2 may also be used as a casing or transport device for the injection device 1. The injection device 1 is operably coupled to or connected to an energy source 4 for charging the injection device 1. In some embodiments, the energy source 4 may comprise a gas cartridge, a battery or a power pack. In some embodiments, a suitable energy source 4 comprises a solar-, battery- or mains-powered electric motor, such that an energy store or storage feature provided in the injection device 1, for example a spring or a pressurized gas system, can be charged from the energy source 4 via a coupling mechanism 5.

In some embodiments, the coupling mechanism 5 can take the form of a valve which is connected to an exchangeable gas cartridge (i.e., the energy source 4) and prevents the pressurized gas stored in the gas cartridge from escaping when the injection device 1 is not connected to the charging device 2. In order to charge the injection device 1, it can be suitably connected to the charging device 2, e.g. snapped onto a locking connection or connected to the charging device 2 via a bayonet or other suitable coupling. The valve can then be moved such that it is opened and pressurized gas can exit from the gas cartridge of the charging device 2 and tense a spring provided in the needle-free injection device 1 via a pneumatic device or can charge a pressurized gas system provided in the injection device 1.

The coupling device 5 can also be configured as a mechanical system, e.g. a spindle, in order to transfer mechanical energy from the energy source 4 to the injection device 1.

The number of charging procedures performed by the energy source 4 is monitored by a service life monitoring system 6 comprising, e.g. a suitable electric system or circuit, and displayed on the counter 3. If a predetermined, approved maximum number of charging procedures is reached, then the service life monitoring system 6 prevents the injection device 1 from being charged again. The injection device 1 has thus reached the end of its service life and must be replaced by a new injection device 1, in order not to suffer any loss in the quality or reliability of the injection device 1.

If, for example, a suitable static memory chip 7, for example an EEPROM, is installed in the injection device 1, then the chip need only be supplied with voltage during a reading or writing procedure. The charging device 2 can be fitted with a reading/writing device 8, in some embodiments a component of or coupled to the monitoring system 6, to read the memory chip installed in the injection device 1 during each reading procedure, in order to read off the number of charging procedures performed in said injection device. Suitably, a current number of the charging procedures performed, increased by one, is then written back into the memory chip. Consequently, an electric energy supply is not necessary in the injection device 1 itself. Using such a memory, fixedly coupled to the injection device 1, the service life of each individual injection device 1 can be monitored individually. When a selected number of charging procedures or injections have been performed, re-charging the injection device 1 is disabled either by the injection device 1 itself or by the charging device 2.

Embodiments of the device and method of the present invention, including preferred embodiments, have been presented for the purpose of illustration and description. They are not intended to be exhaustive or to limit the invention to the precise forms or steps disclosed. Obvious modifications or variations are possible in light of the above teachings. The embodiments were chosen and described to provide the best illustrations of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A needle-free injection device comprising a service life monitoring system.

2. The needle-free injection device as set forth in claim 1, comprising a counting device for counting the charging and/or injection procedures performed.

3. The needle-free injection device as set forth in claim 2, wherein said counting device is arranged in the injection device itself.

4. The needle-free injection device as set forth in claim 1, comprising a memory for storing at least one of the number of charging and injection procedures performed.

5. The needle-free injection device as set forth in claim 4, wherein said memory is arranged in the injection device itself.

6. The needle-free injection device as set forth in claim 4, wherein said memory is an electric memory.

7. The needle-free injection device as set forth in claim 1, further comprising a disabling device for disabling at least one of a charging procedure and an injection procedure when a predetermined maximum number of the charging or injection procedures is reached.

8. The needle-free injection device as set forth in claim 7, wherein said disabling device is arranged in the injection device itself.

9. The needle-free injection device as set forth in claim 1, further comprising at least one of an optical output device and an acoustic output device for outputting the number of at least one of charging procedures and injection procedures performed.

10. The needle-free injection device as set forth in claim 9, wherein said at least one of an optical output device and an acoustic output device is arranged in the injection device itself.

11. The needle-free injection device as set forth in claim 1, further comprising at least one of an optical output device and an acoustic output device for outputting a warning signal before or when a predetermined maximum number of at least one of charging procedures and injection procedures is reached.

12. The needle-free injection device as set forth in claim 11, wherein said at least one of an optical output device and an acoustic output device is arranged in the injection device.

13. The needle-free injection device as set forth in claim 1, further comprising at least one of an optical output device and an acoustic output device for outputting a warning signal when a predetermined period of time has elapsed.

14. The needle-free injection device as set forth in claim 13, wherein said at least one of an optical output device and an acoustic output device is arranged in the injection device itself.

15. A needle-free injection device for performing injections comprising a charging device for performing injection device charging procedures which exhibits at least one of: a service life monitoring system; a counting device for counting at least one of the charging and injection procedures performed; a memory for storing at least one of the number of charging or injection procedures performed; a disabling device for disabling at least one of the charging procedure or injection procedure of said injection device when a predetermined maximum number of the charging or injection procedures is reached; at least one of an optical output device and an acoustic output device for outputting the number of at least one of the charging procedures and the injection procedures performed; at least one of an optical output device and an acoustic output device for outputting a warning signal before or when a predetermined maximum number of at least one of the charging procedures and the injection procedures is reached; and at least one of an optical output device and an acoustic output device for outputting a warning signal once a predetermined period of time has elapsed.

16. The needle-free injection device as set forth in claim 15, further comprising an allocation recognition system whereby said charging device identifies a particular needle-free injection device.

17. The needle-free injection device as set forth in claim 1, further comprising a charging device, wherein said charging device comprises a gas store.

18. The needle-free injection device as set forth in claim 17, wherein said gas store is a pressurized gas cartridge.

19. The needle-free injection device as set forth in claim 1, further comprising a charging device, wherein the charging device comprises an electric energy store.

20. A method for monitoring the service life of a needle-free injection device.

21. The method as set forth in claim 20, comprising counting at least one of the number of charging and injection procedures performed by the device.

22. The method as set forth in claim 21, further comprising disabling the device when at least one of a selected maximum number of charging or injection procedures is reached.

23. A rechargeable needle-free injection system comprising:
a rechargeable needle-free injection device for performing injections;
a charger for performing charging procedures for the injection device, said charger comprising:
an injection device service life monitoring unit comprising a counter for counting at least one of the charging procedures or injections performed, a memory for storing at least one of the number of the charging procedures or injections performed, and a disabling device for disabling at least one of the charging procedures or the injection device when a predetermined maximum number of the charging procedures or injections is reached.

24. The system of claim 23, further comprising at least one of an optical output device and an acoustic output device for outputting the number of at least one of the charging procedures and injections performed.

25. The system of claim 23, further comprising at least one of an optical output device and an acoustic output device for outputting a warning signal before or when a predetermined maximum number of at least one of the charging procedures and injections is reached.

26. The system of claim 23, further comprising at least one of an optical output device and an acoustic output device for outputting a warning signal when a predetermined period of time has elapsed.
